(19) United States
(12) Patent Application Publication
(10) Pub. No.: US 2022/0020508 A1
(43) Pub. Date: Jan. 20, 2022

(54) SILVER NANOWIRE TRANSPARENT CONDUCTIVE FILMS

(71) Applicant: Cambrios Film Solutions Corporation, Tortola (VG)

(72) Inventors: Michael Spaid, Mountain View, CA (US); Derek Tuttle, Santa Clara, CA (US); Pin-Chu Chen, San Jose, CA (US); Jeff Wolk, Half Moon Bay, CA (US); Haixia Dai, Pleasanton, CA (US)

(21) Appl. No.: 17/311,856

(22) PCT Filed: Dec. 26, 2019
(86) PCT No.: PCT/US2019/068515

§ 371 Date: Jun. 8, 2021

Related U.S. Application Data
(60) Provisional application No. 62/785,347, filed on Dec. 27, 2018.

(51) Int. Cl. H01B 1/02

(52) U.S. Cl. CPC H01B 1/02

(57) ABSTRACT

An electrically-conductive film that includes a substrate and a plurality of metal nanostructures supported on the substrate, with the nanostructures connecting to provide a network having electrical conductivity along the network. The film includes a first overcoat matrix on the nanostructures and the substrate, and can includes a second overcoat matrix on the nanostructures and the first overcoat matrix. The second overcoat matrix can have a thickness sufficient to cover the nanostructures and the first overcoat matrix. The film allows an electrical contact material that extends through the second overcoat matrix to electrically connect to the nanostructures at a contact area. The first overcoat matrix can have a thickness within a range of 1 to 3 average diameter of the nanostructures. The combination of the first overcoat matrix and second overcoat matrix can fully cover the nanostructures.

### RELATED APPLICATION

This application claims priority to U.S. Provisional Application Ser. No. 62/785,347, titled “SILVER NANOWIRE TRANSPARENT CONDUCTIVE FILMS” and filed on Dec. 27, 2018, which is incorporated herein by reference.

### FIELD

This disclosure is related to transparent, electrically conductive films, and methods of forming a transparent, electrically conductive film with improved properties concerning electrical contact and film reliability.

### BACKGROUND

Transparent conductors may include optically-clear and electrically-conductive films such as those commonly used in touch-sensitive computer displays. Generally, conductive nanostructures connect with each other to form a percolating network having long-range interconnectivity. The percolating network is connected to electronic circuits of a computer, tablet, smart phone, or other computing device having a touch-sensitive display by cooperating with metal contacts. Also, generally, there is an overcoat layer that is to provide some protection to the nanostructures from both physical and chemical damage/degradation. The overcoat layer is sufficiently thin to permit electrical contact.

### SUMMARY

In accordance with an aspect, there is provided an electrically-conductive film that includes a substrate and a plurality of metal nanostructures supported on the substrate, with the nanostructures connecting to provide a network having electrical conductivity along the network. The film includes a first overcoat matrix on the nanostructures and the substrate, and includes a second overcoat matrix on the nanostructures and the first overcoat matrix. The second overcoat matrix has a thickness sufficient to cover the nanostructures and the first overcoat matrix. The film allows an electrical contact material that extends through the second overcoat matrix to electrically connect to the nanostructures at a contact area.

In accordance with another aspect, there is provided an electrically-conductive film that includes a substrate and a plurality of metal nanostructures supported on the substrate, with the nanostructures connecting to provide a network having electrical conductivity along the network. The film includes at least an overcoat matrix on the nanostructures and the substrate, and allows electrical contact material on top of the at least an overcoat matrix to electrically connect to the nanostructures at a contact area. The contact area has a resistance of less than 200 Ohms.

In accordance with another aspect, there is provided an electrically-conductive film that includes a substrate and a plurality of metal nanostructures supported on the substrate, with the nanostructures connecting to provide a network having electrical conductivity along the network. The film includes a first overcoat matrix on the nanostructures and the substrate. The first overcoat matrix has a thickness within a range of 1 to 3 average diameter of the nanostructures. The film includes a second overcoat matrix on the nanostructures and the first overcoat matrix, with the combination of the first overcoat matrix and second overcoat matrix fully covering the nanostructures.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a schematic cross-section of a film showing nanowire electrical contact points through an overcoat layer.

FIGS. 2A to 2C are example plot of contact resistance of single overcoat silver nanowire film, in accordance with examples of the structure shown in FIG. 1, with the single overcoat being about 40 nm for FIG. 2A, about 60 nm for FIG. 2B and about 80 nm for FIG. 2C.

FIGS. 3A to 3C are three example plots of percentage resistance change vs. exposure time for three example temperature and relative humidity scenarios, in accordance with the structure shown within FIG. 1, which has a single overcoat layer of 40 nm, and is for comparison and contrast to FIGS. 7A to 7B following.

FIG. 4 is a schematic cross-section of a film showing three-layer structure of the silver nanowire film in accordance with at least an aspect of the present disclosure.

FIG. 5 is schematic cross-section of a film showing silver paste contact through three-layer structure of the silver nanowire film shown in FIG. 4, and in accordance with at least an aspect of the present disclosure.

FIG. 6A is an example plot of contact resistance vs. contact area of a double overcoat silver nanowire film, in accordance with the examples of FIGS. 4 and 5 and in accordance with at least an aspect of the present disclosure.

FIG. 6B is a schematic of the Kelvin method to measure contact resistance, with contact area defined by the overlap areas between silver paste lines and silver nanowire conductive film lines, which can be used to provide data for the plot of FIG. 6A.

FIGS. 7A to 7C are three example plots of percentage resistance change vs. exposure time for three example temperature and relative humidity scenarios, in accordance with the examples of FIGS. 4 and 5 and in accordance with at least an aspect of the present disclosure.

FIGS. 8A and 8B are two schematized representations of example narrow border devices in accordance with at least an aspect of the present disclosure with small electrical contacts in the border areas, with FIG. 8A being a sensor film and FIG. 8B being a shielding film.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any illustrative embodiments set forth herein as examples. Rather, the embodiments are provided herein merely to be illustrative.

As used herein, “conductive nanostructures” or “nanostructures” generally refer to electrically conductive nano-sized structures, at least a dimension of which is less than 500 nm, or less than 250 nm, 100 nm, 50 nm, 25 nm, 15 nm, or 10 nm for example. Typically, the nanostructures are made of a metallic material, such as an elemental metal (e.g., transition metals) or a metal compound (e.g., metal oxide). The metallic material can also be a bimetallic material or a metal alloy, which comprises two or more types of metal. Suitable metals include, but are not limited to, silver, gold, copper, nickel, gold-plated silver, platinum and palladium. Within discussion herein silver is presented as a viable example metal. However, the scope of this disclosure is not limited to silver as the metal.

The nanostructures can be of any shape or geometry. The morphology of a given nanostructure can be defined in a simplified fashion by its aspect ratio, which is the ratio of the length over the diameter of the nanostructure. For instance, certain nanostructures are isotropically shaped (i.e., aspect ratio=1). Typical isotropic nanostructures include nanoparticles. In preferred embodiments, the nanostructures are anisotropically shaped (i.e., aspect ratio≠1). The anisotropic nanostructure typically has a longitudinal axis along its length. Exemplary anisotropic nanostructures include nanowires, nanorods, and nanotubes, as defined herein.

The nanostructures can be solid or hollow. Solid nanostructures include, for example, nanoparticles, nanorods and nanowires. Nanowires typically refers to long, thin nanostructures having aspect ratios of greater than 10, preferably greater than 50, and more preferably greater than 100. Typically, the nanowires are more than 500 nm, more than 1 μm, or more than 10 μm long. Nanorods are typically short and wide anistropic nanostructures that have aspect ratios of no more than 10. Although the present disclosure encompasses any type of nanostructure, for the sake of brevity, silver nanowires will be described as an example. The scope of this disclosure is not limited to the example of nanowires or silver nanowires.

The following are some example descriptions. Within the descriptions, nanowires are presented as an example of nanostructures. It is to be appreciated that other types of nanostructures are possible and contemplated, and are thus provided via this disclosure. Of course, different nanostructures could be used within the examples.

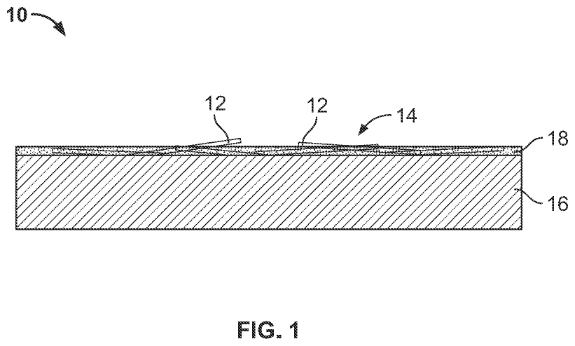

With reference to FIG. 1, a transparent conductive film 10 can be formed via a percolating network of silver nanowires/nanostructures 12 as a layer 14 upon a substrate 16. Typically, the transparent conductive film 10 includes the silver nanowire layer 14 and a protecting film layer 18, which can be coated in one or two passes depending on the coating system design. As such, the protecting film layer 18 is an overcoat. The nanowires 12 within the network connect and thus have electrical conductivity along the network.

Concerning an example production method: first, silver nanowire ink containing silver and polymer binder materials is coated on a plastic film as the substrate 16 and the ink is subsequently dried as such intermediate product passes through a series of ovens with increasing temperature. Next, the protective layer or “overcoat” layer 18, which can be a polymer, is coated on top of the silver nanowire layer to protect it. The overcoat film layer 18 can be considered to be an overcoat matrix.

In contrast to a traditional indium tin oxide (ITO) film which has a continuous conductive layer, the final silver nanowire film consists of a percolating network of conductive silver nanowires 12 and most of the area is actually space between the conductive nanowires. The way to make electrical contact with the layer 14 of the silver nanowires 12 of the transparent conductive film 10 is via the points of nanowire network that are exposed, partially exposed, or become exposed further processing through the overcoat layer (see FIG. 1). Herein, the aspects of exposed, partially exposed, or become exposed can be holistically/generically referred to as being exposed. It is to be appreciated that the amount/type of such exposure need not be a specific limitation upon this disclosure. In an example of such exposure, the nanowires can be considered to be at least partially uncovered from the overcoat layer. In another example, the nanowires can be considered to protrude from the overcoat layer. Within an example, an electrical contact material (e.g., silver paste), not shown within FIG. 1, makes electrical contact with exposed portions of the nanowires 12 when applied onto the overcoat film layer 18 from which the nanowires are exposed. Herein silver paste is often presented as an example of electrical contact material. It is to be appreciated that many variants of electrical contact material, and specifically variants of silver paste, are possible and contemplated, and are thus provided via this disclosure and can be used within the presented examples. However, the example of silver paste, and possibly specifically variants thereof, are not limitations upon the scope of this disclosure.

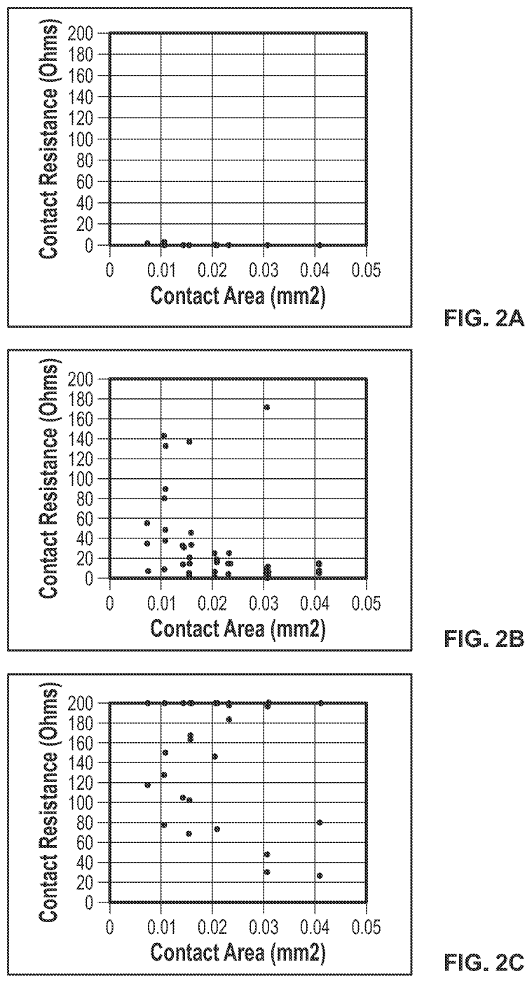

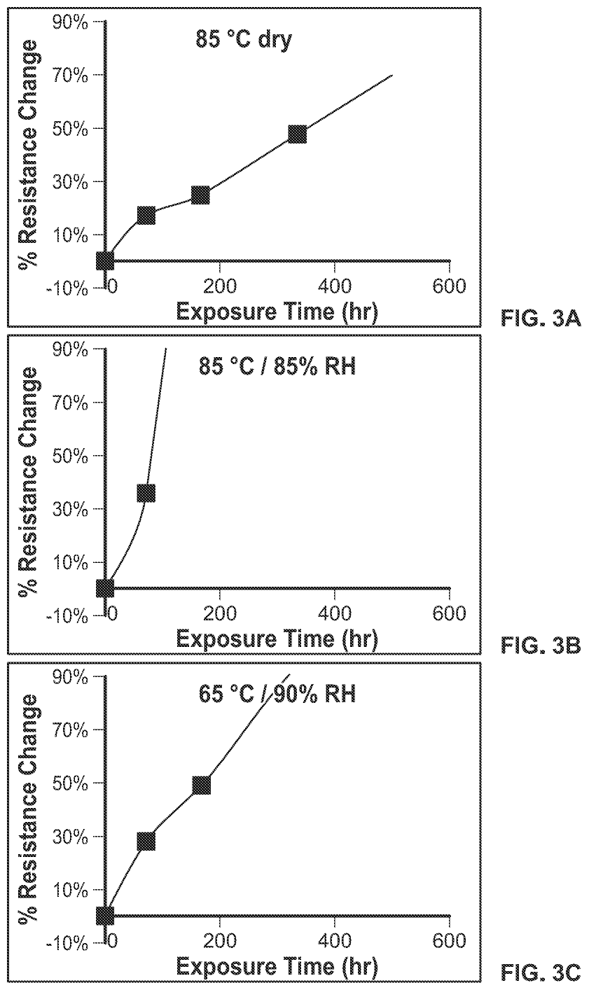

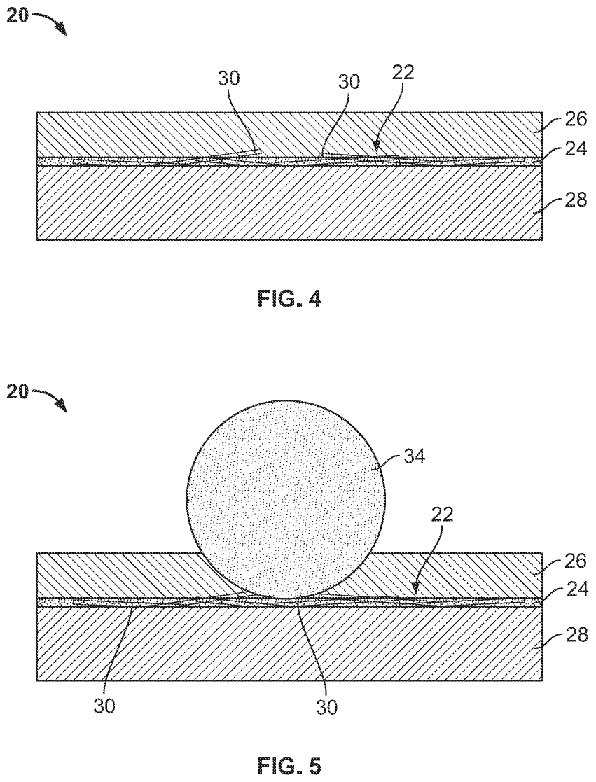

The overcoat film layer 18 (FIG. 1) has to be designed specifically to protect silver nanowire layer 14 from both physical and chemical damage/degradation, while the contact resistance to the nanowire network can be controlled by the overcoat thickness. The overcoat film layer 18 of FIG. 1 has to be thick enough to provide mechanical integrity but thin enough to facilitate electrical contact on the surface. It is very challenging to meet both requirements at one particular thickness. Considering the recent trend of narrow bezel or no bezel display devices, a very small electrical contact area between the electrical contacting material and the patterned silver nanowire transparent conductive lines is required. The small contact areas make it very challenging to simultaneously achieve low electrical contact resistance while maintaining good film reliability. For example, a silver nanowire layer with 40 nm overcoat (FIG. 2A) has contact resistance less than 20 ohm for contact areas over 0.01 mm². As shown within FIG. 2B, contact resistance is increased for a 60 nm overcoat. A film with 80 nm overcoat (FIG. 2C) has a much higher contact resistance and many points are more than 200 ohms. However, the low contact resistance film such as the 40 nm overcoat film cannot pass the typical environmental reliability test as shown in FIGS. 3A-3C, with the film sheet resistance changed (i.e., increased) quickly over 20% in less than 200 hours. For the single overcoat layer film, FIGS. 3A-3C show more than 20% resistance change in a very short time of around 200 hours. Such results may not be acceptable.

Turning to FIG. 4, an example that provides as least an aspect in accordance with the present disclosure is shown.

It is to be appreciated that an aspect in accordance with the present disclosure is a new film stack structure which can meet all the requirements of mechanical integrity, environmental protection, and good electrical contacts.

Within the example shown within FIG. 4, a new film stack 20 includes three layers 22-26 on top of a substrate 28. As shown in FIG. 4, the three layers are: a first, silver nanowire layer 22 of nanowires 30, a cross-linked polymer layer 24 as a first overcoat layer, and a non-cross-linked polymer layer 26 as a second overcoat layer. The first overcoat layer 24 can be considered to be a first overcoat matrix. The second overcoat layer 26 can be considered to be a second overcoat matrix.

Again, the silver nanowires are just an example. As used herein, “conductive nanostructures” or “nanostructures” generally refer to electrically conductive nano-sized structures, at least an dimension of which is less than 500 nm, or less than 250 nm, 100 nm, 50 nm, 25 nm, 15 nm, or 10 nm for example. Typically, the nanostructures are made of a metallic material, such as an elemental metal (e.g., transition metals) or a metal compound (e.g., metal oxide). The metallic material can also be a bimetallic material or a metal alloy, which comprises two or more types of metal. Suitable metals include, but are not limited to, silver, gold, copper, nickel, gold-plated silver, platinum and palladium.

The nanostructures can be of any shape or geometry. The morphology of a given nanostructure can be defined in a simplified fashion by its aspect ratio, which is the ratio of the length over the diameter of the nanostructure. For instance, certain nanostructures are isotropically shaped (i.e., aspect ratio=1). Typical isotropic nanostructures include nanoparticles. In preferred embodiments, the nanostructures are anisotropically shaped (i.e., aspect ratio≠1). The anisotropic nanostructure typically has a longitudinal axis along its length. Exemplary anisotropic nanostructures include nanowires, nanorods, and nanotubes, as defined herein.

The nanostructures can be solid or hollow. Solid nanostructures include, for example, nanoparticles, nanorods and nanowires (“NWs”). NWs typically refers to long, thin nanostructures having aspect ratios of greater than 10, preferably greater than 50, and more preferably greater than 100. Typically, the nanowires are more than 500 nm, more than 1 μm, or more than 10 μm long. Nanorods are typically short and wide anistropic nanostructures that have aspect ratios of no more than 10. Although the present disclosure encompasses any type of nanostructure, for the sake of brevity, silver nanowires will be described as an example, but not as a limitation upon the disclosure (i.e., different nanostructures and/or different metals could be used within the examples). The nanowires 30 within the percolating network connect/contact between/among adjacent/near neighboring nanowires and thus have electrical conductivity along the network.

Typically, the cross-linked polymer layer 24 as a first overcoat layer is very thin, and can provide good mechanical integrity and good surface exposure of electrical contact points of the nanowires 30. In some examples, the first overcoat layer 24 may have a thickness that may be related to nanowire diameter. Within some examples, the thickness of the first overcoat layer 24 can be: less than five nanowire diameters, less than three nanowire diameters, or within a range of one to three nanowire diameters. As some examples, if the nanowires 30 have a diameter of 20 nm, the first overcoat layer 24 could have a thickness in the range of 20-60 nm. The non-cross-linked polymer second overcoat layer 26 is typically thicker and provides good environment protection during chemical or physical exposures.

It is to be appreciated that the above mentioned first overcoat layer 24, itself, is not specified to either: (a) provide for exposure/partial exposure of the nanowires or (b) provide for no exposure/partial exposure of the nanowires. So, it is to be appreciated that, unless the first overcoat layer 24 is specified to: (a) provide for exposure/partial exposure of the nanowires 30 or (b) provide for no exposure/partial exposure of the nanowires, that the first overcoat layer should be considered to be either of such options.

In addition to the aspect(s) of protection, the second overcoat layer 26 allows (will allow) an example silver paste 34 (as an example of electrical contact material) to have electrical contacts through this thick polymer, second overcoat layer as shown (schematically, of course) within FIG. 5.

The reason the silver paste 34 can penetrate the second overcoat layer 26 is because the second overcoat has at least a property to permit penetration of electrical contact material (e.g., the silver paste 34) through the second overcoat matrix to the at least portion of the nanowires 30 being exposed from the first overcoat matrix. As some examples, the second overcoat layer 26 is of material(s) that has at least one of the following: a solubility by a solvent within the electrical contact material (e.g., the silver paste 34), an ability to reflow during heating, a lower melt temperature than the electrical contact material, or a lower deformation resistance than the electrical contact material.

So, from an example perspective, the second overcoat layer 26 is either designed to be soluble in the solvent of the silver paste 34, and/or the silver paste can sink though the second overcoat via application of heat or pressure or both. In a still further example, the second overcoat layer 26 can be designed to be simultaneously soluble in the solvent of the silver paste 34 and the silver paste can sink though the second overcoat via application of heat and the silver paste can sink though the second overcoat via application of pressure (i.e., all three simultaneously).

It is to be appreciated that silver paste is presented as an example. It is to be appreciated that other materials, other metals and/or other structures are contemplated to be used within other examples to provide one or more of the above discussed functions. As such, silver paste is not a limitation upon the disclosure.

As an example for the transparent conductive film 20, the first overcoat layer 24 is UV curable acrylate and example of the second overcoat layer 26 is linear polymers such as polymethyl methacrylate (PMMA), a copolymer of methyl methacrylate, Polycarbonate, etc. In a general example type, the first overcoat material is a cross-linked polymer that is preferably at least resistant to the solvent of the silver paste and the second overcoat material is a linear polymer that is not cross-linked. It is to be appreciated that these discussed materials for the first overcoat layer and the second overcoat layer 26 are only examples and are not limitations upon the disclosure. Other materials are possible and contemplated and within the scope of this disclosure. Such other materials could be selected based upon materials for the nanostructures ad/or the paste, or substitute(s) thereof.

An example stack of the three-layer transparent conductive film 20 is provided by an example method of: coating on a clear plastic substrate 28 that has ink receptive coatings applied (primers) with silver nanowire (e.g., Cambrios' nanowire with average diameter of 20 nm) layer 22 at 10-200 ohm/sq and a 20-60 nm UV curable acrylate first overcoat layer 24 and a second overcoat layer 26 of over 50 nm PMMA overcoat. The film has high transmission (>90%), low haze (<1%), and low transmission color b*(<2). The film passed adhesion tests based on ASTM-3359 test method B using 3M 610 tape. The clear plastic substrate 28 here can be any substrate like COP, PET, clear PI, PC, TAC films or any other clear plastic substrates. The substrates can have primer layers or hardcoats on the surface.

In some example(s), the at least one property to permit penetration of electrical contact material (e.g., silver paste 34) through the second overcoat matrix to the at least portion of the nanostructures (e.g., nanowires) being exposed from the first overcoat matrix includes material of the second overcoat matrix that has an ability to reflow during heating and/or a lower melt temperature than the electrical contact material such that the material of the second overcoat matrix can be heated to permit penetration of the electrical contact material through the second overcoat matrix to the at least portion of the nanostructures exposed from the first overcoat matrix. Additionally/alternatively, the at least one property to permit penetration of electrical contact material through the second overcoat matrix to the at least portion of the nanostructures being exposed from the first overcoat matrix includes material of the second overcoat matrix that is has a lower deformation resistance than the electrical contact material such that the electrical contact material can be pressed to penetration through the second overcoat matrix to the at least portion of the nanostructures exposed from the first overcoat matrix. Such (either/both) allows the electrical contact material (e.g., possibly paste) to be settled (e.g., sink), or even be forced via application of pressure thereto, through the second overcoat to reach the nanostructures.

With regard to an ability to reflow during heating melt, it is to be appreciated that for such an aspect specific details regarding possible melt temperatures need not be specific limitations. As such, in some examples, the second overcoat matrix need not be heated to its melt temperature so long as reflow can occur. Also, the melt temperatures of the second overcoat matrix and the first overcoat matrix may be close, nearly the same or the same. So, the task to be accomplished is to reflow the second overcoat matrix during heating. For all such example variations, it is to be appreciated that formation of electrical contact is permitted to be formed via the reflow of the second overcoat matrix during heating for these example variations.

Again, the understanding is to be that specifics concerning the at least one property to permit penetration of the electrical contact material through the second overcoat matrix to the at least portion of the nanostructures can be varied and should be broadly understood as such from the disclosure herein. Accordingly, different materials, structures, etc. are contemplated and within the scope of this disclosure.

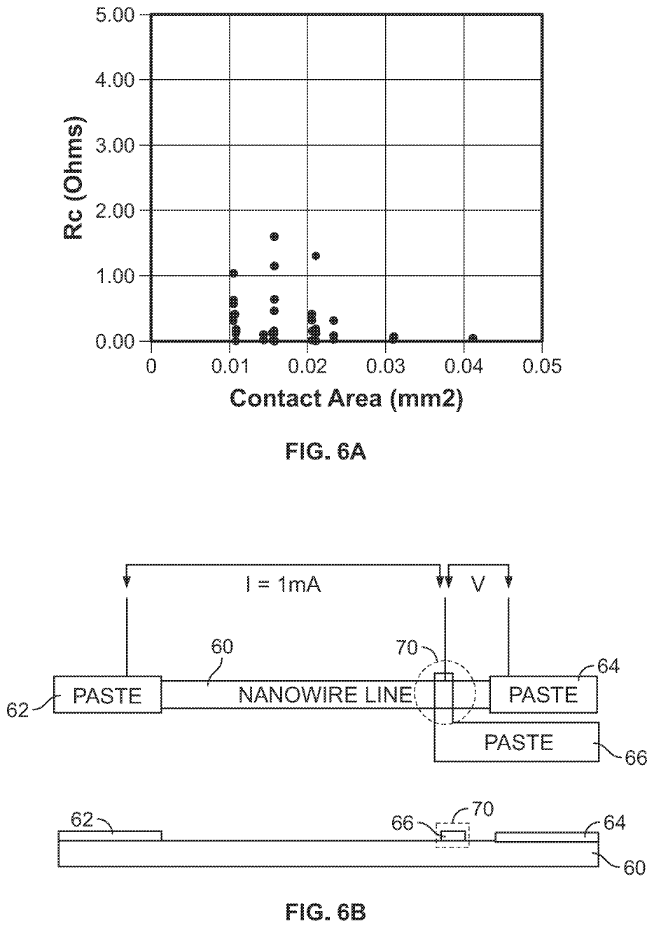

Focusing back to the example film discussed above in connection with FIGS. 4 and 5, such example film gave very low surface contact resistance as shown in FIG. 6A, less than 2 ohm resistance at contact area sizes above 0.01 mm².

FIG. 6B shows a schematic of Kelvin method to measure contact resistance. Such is applicable for various different contact area sizes. Specifically, FIG. 6B presents both a top view and an aligned side view of a nanowire line 60, and a specific contact area as described below, for testing. The nanowire line 60 is electrically contacted at each of two ends by paste portions 62 and 64 and also electrically contacted at an intermediate location along the nanowire line 60 by a paste portion 66. The nanowire line 60 is provided as a percolating network of nanowires (e.g., 30, FIGS. 4 and 5). The paste portions 62-66 are of the paste 34 (e.g., FIG. 5). A contact area 70 is defined by the overlap area (encircled with dashed lines within each of the two views of FIG. 6B) between silver paste portion 66 and silver nanowire line 60.

It is worth noting that a similar type of testing (i.e., using the Kelvin method) to measure contact resistance can be used concerning the conductive film 10 (FIG. 1) to obtain the plots of FIGS. 2A-2C.

Focusing back to the example testing the example film discussed above in connection with FIGS. 4 and 5: within an example of the testing, the nanowire line 60 has a width in the top view of 0.1 to 0.2 mm and the paste portion 66 that overlies the nanowire line 60 has a transverse width (i.e., perpendicular to the width of the nanowire line) of 0.1 to 0.2 mm). Also, within an example of the test, a current of 1 mA is passed through the nanowire line 60 (e.g., from paste portion 62 to paste portion 66). Voltage is measured between paste portion 66 and paste portion 64 and the contact resistance within the contact area 70 (with the resistance as plotted within the example of FIG. 6A) is calculated by the measured voltage dividing the applied current of 1 mA.

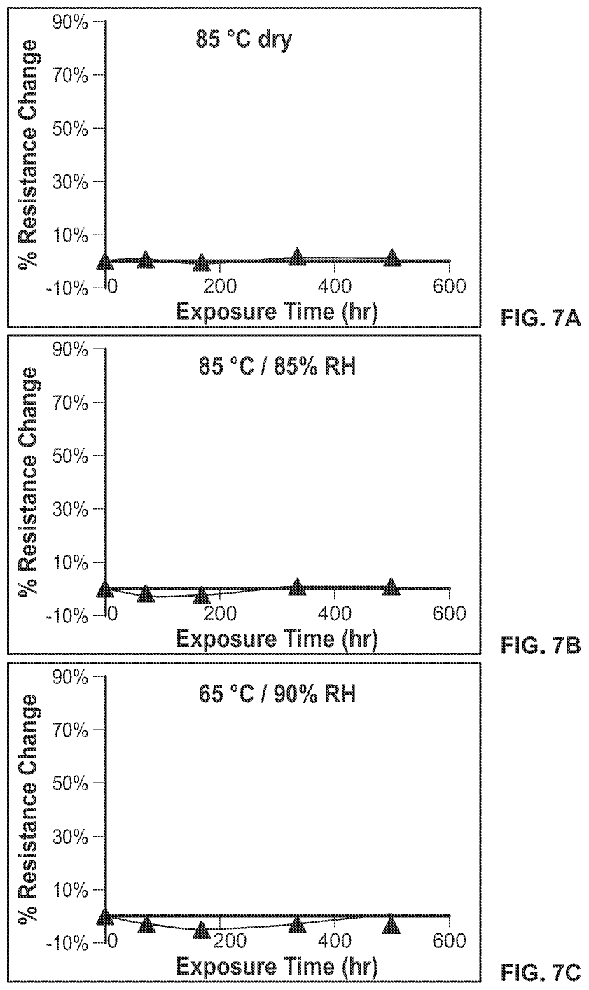

Moreover, the double overcoat film passed bare film reliability tests in various chamber conditions as listed in FIG. 7A-7C, less than 20% film resistance change in 85° C. dry, 85° C./85 RH, 65° C./90 RH (with RH being relative humidity). Such shows good stability provided, as such is in contrast to a dramatic film resistance increase (i.e., see FIGS. 3A-3C) for that of the single overcoat layer film without the second overcoat as shown in FIG. 1. Recall that the results for the FIG. 1 film is shown in FIGS. 3A-3C, and shows, more than 20% in a very short time of around 200 hours. In general, see that the curves within FIG. 3A-3C go upward drastically as compared to the curves within the counterparts of FIG. 7A-7C.

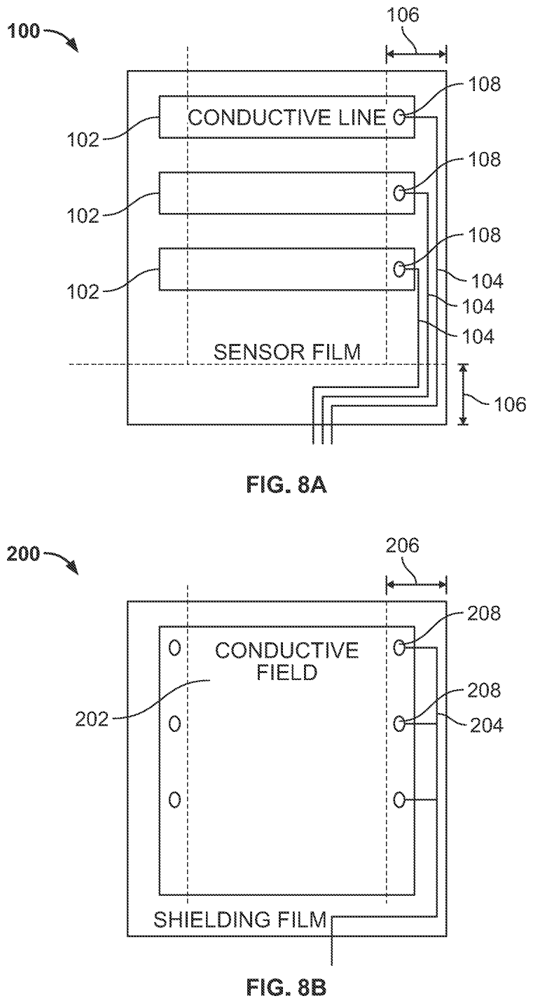

The very low electrical contact resistance at very small contact sizes are beneficial for narrow bezel or “bezel free” display devices. For example, with very low electrical contact resistance, the overlapping areas between the conductive elements (silver nanowire conductive lines) in a display area and connecting traces (silver or other metals paste lines) for routing the conductive elements in the display border/bezel area can be very small and therefore occupies a small area for the electrical contacts. As some examples, FIG. 8A shows a schematic of an example sensor film 100 and FIG. 8B shows an example shielding film 200, each with respective conductive lines/field 102, 202 and connecting traces 104, 204 in a respective display border/bezel area 106, 206. So, with a small contact size and fine pitches, narrow bezel (borders) 106, 206 can be achieved.

Focusing upon FIG. 8A, the example sensor film 100 includes the conductive lines 102. The conductive lines 102 may be of the construction of the film 20 as set forth in connection with FIGS. 4 and 5 and the associated text discussion. Specifically, the conductive lines 102 may have the first, silver nanowire layer 22 of nanowires 30, the cross-linked polymer layer 24 as the first overcoat layer, and the non-cross-linked polymer layer 26 as the second overcoat layer (e.g., see FIG. 4). The silver paste contacts 34 (e.g., see FIG. 5) may be within the bezel area 106 (FIG. 8A) so as to provide electrical connection between the lines 102 and the traces 104 to provide a contact area 108. As discussed, the contact area 108 can be very small, which in turn can provide for a bezel area 106 that is very small. Specifically, the bezel area 106 is narrow. Such, visually is appealing since the bezel area 106 is barely noticeable or may even appear to be “bezel free” (i.e., the display device appears to not have a bezel).

Turning now to FIG. 8B, the example shielding film 200 includes the conductive field 202. The conductive field 202 may be of the construction of the film 20 as set forth in connection with FIGS. 4 and 5 and the associated text discussion. Specifically, the conductive field 202 may have the first, silver nanowire layer 22 of nanowires 30, the cross-linked polymer layer 24 as the first overcoat layer, and the non-cross-linked polymer layer 26 as the second overcoat layer (e.g., see FIG. 4). The silver paste contacts 34 (e.g., see FIG. 5) may be within the bezel area 206 (FIG. 8A) so as to provide electrical connection at a contact area 208 between the field 202 and the traces 204. As discussed, the contact area 208 can be very small, which in turn can provide for a bezel area 206 that is very small. Specifically, the bezel area 206 is narrow. Such, visually is appealing since the bezel area 206 is barely noticeable or may even appear to be “bezel free” (i.e., the display device appears to not have a bezel).

Of course, the method(s) of making the film(s) discussed above are contemplated and are included herein.

As some example aspects and features provided herein, the following are noted.

An electrically-conductive film that includes a substrate and a plurality of metal nanostructures supported on the substrate, with the nanostructures connecting to provide a network having electrical conductivity along the network. The film includes a first overcoat matrix on the nanostructures and the substrate, and includes a second overcoat matrix on the nanostructures and the first overcoat matrix. The second overcoat matrix has a thickness sufficient to cover the nanostructures and the first overcoat matrix. The film allows an electrical contact material that extends through the second overcoat matrix to electrically connect to the nanostructures at a contact area.

At least a portion of the nanostructures can be exposed from the first overcoat matrix. The second overcoat matrix can have a thickness sufficient to cover the at least portion of the nanostructures exposed from the first overcoat matrix and the electrical contact material can extend through the second overcoat matrix to electrically contact the at least portion of the nanostructures exposed from the first overcoat matrix at a contact area.

The second overcoat matrix can include non-cross-linked polymer.

The second overcoat matrix can include at least one of polymethyl methacrylate, a copolymer of methyl methacrylate, or polycarbonate.

The first overcoat matrix can include UV curable acrylate.

The second overcoat matrix can have at least one property to permit penetration of the electrical contact material through the second overcoat matrix.

The electrical contact material can include a solvent and the at least one property to permit penetration of the electrical contact material through the second overcoat matrix includes material of the second overcoat matrix that is soluble by the solvent.

The at least one property to permit penetration of electrical contact material through the second overcoat matrix includes material of the second overcoat matrix that can have at least one of the following: a solubility by a solvent within the electrical contact material, an ability to reflow during heating, a lower melt temperature than the electrical contact material, or a lower deformation resistance than the electrical contact material.

An electrically-conductive film that includes a substrate and a plurality of metal nanostructures supported on the substrate, with the nanostructures connecting to provide a network having electrical conductivity along the network. The film includes at least an overcoat matrix on the nanostructures and the substrate, and allows electrical contact material on top of the at least an overcoat matrix to electrically connect to the nanostructures at a contact area. The contact area has a resistance of less than 200 Ohms.

The contact area can have a resistance of less than 140 Ohms.

The contact area can have a size within a range of 0.01 to 0.05 mm².

The contact area can have a size within a range of 0.01 to 0.025 mm².

The at least an overcoat matrix can include a first overcoat matrix on the nanostructures and the substrate and a second overcoat matrix on the nanostructures and the first overcoat matrix. The second overcoat matrix can have a thickness sufficient to cover the nanostructures and the first overcoat matrix, and the contact area can have a resistance of less than 2 Ohms.

The first overcoat matrix can have a thickness within a range of 1 to 3 average diameter of the nanostructures.

The first overcoat matrix can include UV curable acrylate and the second overcoat matrix can include non-cross-linked polymer.

An electrically-conductive film that includes a substrate and a plurality of metal nanostructures supported on the substrate, with the nanostructures connecting to provide a network having electrical conductivity along the network. The film includes a first overcoat matrix on the nanostructures and the substrate. The first overcoat matrix has a thickness within a range of 1 to 3 average diameter of the nanostructures. The film includes a second overcoat matrix on the nanostructures and the first overcoat matrix, with the combination of the first overcoat matrix and second overcoat matrix fully covering the nanostructures.

The first overcoat matrix can have a thickness within a range of 20-60 nm.

The film can allow an electrical contact material extending through the second overcoat matrix to electrically connect to the nanostructures at a contact area.

The contact area can have a resistance of less than 200 Ohms.

The electrical contact material can have at least one property to permit penetration of electrical contact material through the second overcoat matrix which can include at least one of the following: a solubility by a solvent within the electrical contact material, an ability to reflow during heating, a lower melt temperature than the electrical contact material, or a lower deformation resistance than the electrical contact material.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example,” “illustrative embodiment,” are used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments and/or examples are provided herein. The order in which some or all of the operations are described herein should not be construed as to imply that these operations are necessarily order dependent. Alternative ordering will be appreciated by one skilled in the art having the benefit of this description. Further, it will be understood that not all operations are necessarily present in each embodiment and/or example provided herein. Also, it will be understood that not all operations are necessary in some embodiments and/or examples.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. An electrically-conductive film comprising:
a substrate;
a plurality of metal nanostructures supported on the substrate with the nanostructures connecting to provide a network having electrical conductivity along the network;
a first overcoat matrix on the nanostructures and the substrate;
a second overcoat matrix on the nanostructures and the first overcoat matrix, the second overcoat matrix having a thickness sufficient to cover the nanostructures and the first overcoat matrix; and
an electrical contact material extending through the second overcoat matrix to electrically connect to the nanostructures at a contact area.

2. The film of claim 1, wherein at least a portion of the nanostructures are exposed from the first overcoat matrix, the second overcoat matrix has a thickness sufficient to cover the at least portion of the nanostructures exposed from the first overcoat matrix and the electrical contact material extending through the second overcoat matrix to electrically contact the at least portion of the nanostructures exposed from the first overcoat matrix at a contact area.

3. The film of claim 1, wherein the second overcoat matrix includes non-cross-linked polymer.

4. The film of claim 1, wherein the second overcoat matrix includes at least one of polymethyl methacrylate, a copolymer of methyl methacrylate or polycarbonate.

5. The film of claim 1, wherein the first overcoat matrix includes UV curable acrylate.

6. The film of claim 1, wherein the second overcoat matrix has at least one property to permit penetration of the electrical contact material through the second overcoat matrix.

7. The film of claim 6, wherein the electrical contact material includes a solvent and the at least one property to permit penetration of the electrical contact material through the second overcoat matrix includes material of the second overcoat matrix that is soluble by the solvent.

8. The film of claim 6, wherein the at least one property to permit penetration of electrical contact material through the second overcoat matrix includes material of the second overcoat matrix that has at least one of the following:
a solubility by a solvent within the electrical contact material,
an ability to reflow during heating,
a lower melt temperature than the electrical contact material, or
a lower deformation resistance than the electrical contact material.

9. An electrically-conductive film comprising:
a substrate;
a plurality of metal nanostructures supported on the substrate with the nanostructures connecting to provide a network having electrical conductivity along the network;
at least one overcoat matrix on the nanostructures and the substrate; and
electrical contact material on top of the at least one overcoat matrix to electrically connect to the nanostructures at a contact area, the contact area having a resistance of less than 200 Ohms.

10. The film of claim 9, wherein the contact area has a resistance of less than 140 Ohms.

11. The film of claim 9, wherein the contact area has a size within a range of 0.01 to 0.05 mm².

12. The film of claim 11, wherein the contact area has a size within a range of 0.01 to 0.025 mm².

13. The film of claim 9, wherein the at least one overcoat matrix includes a first overcoat matrix on the nanostructures and the substrate, and a second overcoat matrix on the nanostructures and the first overcoat matrix, the second overcoat matrix has a thickness sufficient to cover the nanostructures and the first overcoat matrix, and the contact area has a resistance of less than 2 Ohms.

14. The film of claim 13, wherein the first overcoat matrix has a thickness within a range of 1 to 3 average diameter of the nanostructures.

15. The film of claim 13, wherein the first overcoat matrix includes UV curable acrylate and the second overcoat matrix includes non-cross-linked polymer.

16. An electrically-conductive film comprising:
a substrate;
a plurality of metal nanostructures supported on the substrate with the nanostructures connecting to provide a network having electrical conductivity along the network;
a first overcoat matrix on the nanostructures and the substrate, the first overcoat matrix having a thickness within a range of 1 to 3 average diameter of the nanostructures; and
a second overcoat matrix on the nanostructures and the first overcoat matrix, with the combination of the first overcoat matrix and second overcoat matrix fully covering the nanostructures.

17. The film of claim 16, wherein the first overcoat matrix has a thickness within a range of 20-60 nm.

18. The film of claim 16, including an electrical contact material extending through the second overcoat matrix to electrically connect to the nanostructures at a contact area.

19. The film of claim 18, wherein the contact area has a resistance of less than 200 Ohms.

20. The film of claim 18, wherein the electrical contact material has at least one property to permit penetration of electrical contact material through the second overcoat matrix which is at least one of the following:
a solubility by a solvent within the electrical contact material,
an ability to reflow during heating,
a lower melt temperature than the electrical contact material, or
a lower deformation resistance than the electrical contact material.
